(19) United States
(12) Patent Application Publication
(10) Pub. No.: US 2013/0111667 A1
(43) Pub. Date: May 9, 2013

(54) Multi-Functional, Convertible Treatment-Table

(71) Applicant: Edna STERN, Nizzan (IL)

(72) Inventor: Edna STERN, Nizzan (IL)

(21) Appl. No.: 13/288,214

(22) Filed: Nov. 3, 2011

(51) Int. Cl. A61G 13/08; A61G 7/02; B23P 17/00; A61G 13/04

(52) U.S. Cl. 5/604; 5/611; 29/401.1

(57) ABSTRACT

A multi-functional, convertible treatment-table configured to be converted from one type of medical furniture to another and to be further adapted by fitting it with interchangeable, specialized medical furnishings.

### FIELD AND BACKGROUND OF THE INVENTION

The present invention relates to a convertible treatment-table and, in particular, it is concerned with enabling an end user to readily convert a single treatment-table into various types of medical furniture needed for a wide range of treatments without a need for construction related activities like sawing, drilling, welding, gluing and the like.

It is well-known that health institutions providing various health services must be equipped with sufficient equipment to adequately enable their professionals to address a wide range of medical issues effectively. Frequently, this requires large capital investments and corresponding storage facilities. This problem is compounded when medical practitioners change or expand their area of focus. Many times the specialized equipment already in their possession is rendered useless and the institution is required to make additional capital outlays.

Therefore, it would be advantageous for health institutions to minimize equipment expenditures by consolidating various equipment requirements into multifunctional, versatile units capable of providing a wide variety of functionality.

U.S. Pat. No. 5,479,666 discloses and convertible bed capable of being converted into a chair, thereby alleviating a portion of the equipment significant expenditures and storage requirements.

However, many treatments require more specialized equipment and not just a bed or a chair. Consequently this solution patent does not adequately address the need to reduce capital outlay and storage space for a variety of specialized medical furnishings. By way of example, gynecological chairs cannot be use by proctologist, and a proctologic table cannot be readily used by cosmetician, a otolaryngologist, a physiotherapist, or a surgeon. Furthermore, a proctologic table cannot be used as a hospital bed, as a stretcher, an operating table, a cosmetician's chair, or a veterinarian table.

Therefore, there is a need to for a multi-functional piece of medical furniture capable of being easily modified to provide the functionality of a specialized treatment table, chair, stretcher, or bed.

### SUMMARY OF THE INVENTION

The present invention is a multi-functional, convertible treatment-table configured to be converted from one type of medical furniture to another and to be further adapted by fitting it with interchangeable, specialized medical furnishings.

According to the teachings of the present invention there is provided multi-functional, convertible treatment-table including: (a) a support frame having at least two, pivotally connected frame segments enabling at least one of the segments to form an angle of inclination relative to a horizontal plane; the frame segments having a plurality of connection configurations for releasably connecting interchangeable furnishings to any one of the frame segments; (b) a lift mechanism configured to vary the height of the support frame; and (c) an interchangeable furnishing releasably connected to at least one of the frame segments, thereby enabling the table to be converted to specialized piece of equipment in accordance with patient needs.

According to a further feature of the present invention, the lift mechanism is further configured to change an angle of inclination of at least one support frame segment.

According to a further feature of the present invention, the interchangeable furnishing includes a support pad.

According to a further feature of the present invention, the support pad includes a plurality of pad segments.

According to a further feature of the present invention, the support pad segment includes a plurality of separate, pad sections enabling independent motion of at least one of the pad sections.

According to a further feature of the present invention, the support pad includes a recess in lateral edge so as to facilitate cable access to a patient lying on the treatment-table.

According to a further feature of the present invention, the support pad includes a discharge recess in a distal edge so as to enable bodily discharges from a patient on the treatment-table to pass through the support pad.

According to a further feature of the present invention, there is also provided a collection pan for receiving the bodily discharges, the collection pan being disposed directly underneath the discharge recess.

According to a further feature of the present invention, there is also provided includes at least one accessory associated with the treatment-table.

According to a further feature of the present invention, the accessory includes a proctologic shelf.

According to a further feature of the present invention, the accessory includes a metallic platform.

There is also provided according to the teachings of the present invention, a method for converting a multi-functional, convertible treatment-table including: (a) providing: i. a support frame having at least two, pivotally connected frame segments enabling at least one of the segments to form an angle of inclination relative to a horizontal plane; the frame segments having a plurality of connection configurations for releasably connecting interchangeable furnishings to the frame segments, ii. a lift mechanism configured to vary the height of the support frame, iii. a first interchangeable furnishing releasably connected to at least one of the frame segments; (b) releasing the first interchangeable furnishing from the frame segment; and (c) releasably connecting a second, interchangeable furnishing to the frame so as to adapt the treatment-table according to patient needs.

According to a further feature of the present invention, there is also provided a step of replacing one of the frame segments with a frame segment having a plurality of pivotal sections.

According to a further feature of the present invention, the second interchangeable furnishing including a support pad segment having a plurality of separate, pad sections enabling independent motion of at least one of the pad sections.

According to a further feature of the present invention, there is also provided a step of adding an accessory associated with the treatment-table.

According to a further feature of the present invention, the accessory includes a wheel set so as to facilitate transport of the treatment-table.

According to a further feature of the present invention, the accessory includes a proctologic shelf.

According to a further feature of the present invention, the accessory includes gynecologic leg rests.

According to a further feature of the present invention, there is also provided adding a collection pan for receiving bodily discharges from a patient on the treatment-table.

According to a further feature of the present invention, the second interchangeable furnishing includes a metallic platform.

### BRIEF DESCRIPTION OF THE DRAWINGS

The invention is herein described, by way of example only, with reference to the accompanying drawings, wherein:

FIG. 1 is a schematic, perspective view of a multi-functional, convertible treatment-table.

FIG. 2 is a schematic, perspective view of a multi-functional, convertible treatment-table converted into a hospital bed

FIGS. 3-5 are schematic, side views of the hospital bed of FIG. 2 disposed at various angles and heights.

FIG. 6 is a schematic, side view of a multi-functional, convertible treatment-table depicting a support frame having three releasable, pivotally connected frame segments.

FIG. 7 is a schematic, bottom view of a support pad having three interconnected pad segments.

FIG. 8 is a schematic, top view of a support structure having three, releasable, pivotally connected frame segments.

FIG. 9 is a schematic, perspective view of the treatment-table converted to broad physiotherapy table.

FIG. 10 is a schematic, perspective view of the treatment-table converted into a two-pad, cardiovascular table.

FIG. 11 is a schematic, perspective view of the treatment-table converted into a stretcher.

FIG. 12 is a schematic, perspective view of the treatment-table converted into a proctologic table.

FIG. 13 is a schematic, perspective view of the treatment-table converted into a combination gynecologic/ urologic chair.

FIG. 14 is a schematic, perspective view of the treatment-table converted into an otolaryngological chair.

FIG. 15 is a schematic, perspective view of the treatment-table converted to a casting.

FIG. 16 is a schematic, top view of the support frame having a frame segment with two, independent, pivotal sections providing the functionality of the casting chair of FIG. 15.

FIG. 17 is a schematic, side view of the support frame of FIG. 16.

FIG. 18 is a schematic, perspective views of the treatment-table converted to a combination chiropractic chair with a head pad having three-independently mobile sections.

FIG. 19 is a schematic, top view of the support frame having a frame segment with three, independent, pivotal sections enabling the functionality of the combination chiropractic chair and table of FIG. 18.

FIGS. 20-21 are schematic, side views of the support frame of FIG. 19.

FIG. 22 is a schematic, perspective view of the treatment-table converted to a washing bed fitted with guard railings.

FIG. 23 is a schematic, perspective view of the treatment-table converted to a veterinarian table fitted with various accessories.

### DESCRIPTION OF THE PREFERRED EMBODIMENTS

The present invention is multi-functional, convertible treatment-table enabling a user to easily convert the treatment-table into a chair, a stretcher, or a bed, or vice versa, and adapt it to a wide variety of specialized uses by adding or removing specialized medical furnishings according to the particular needs of each patient.

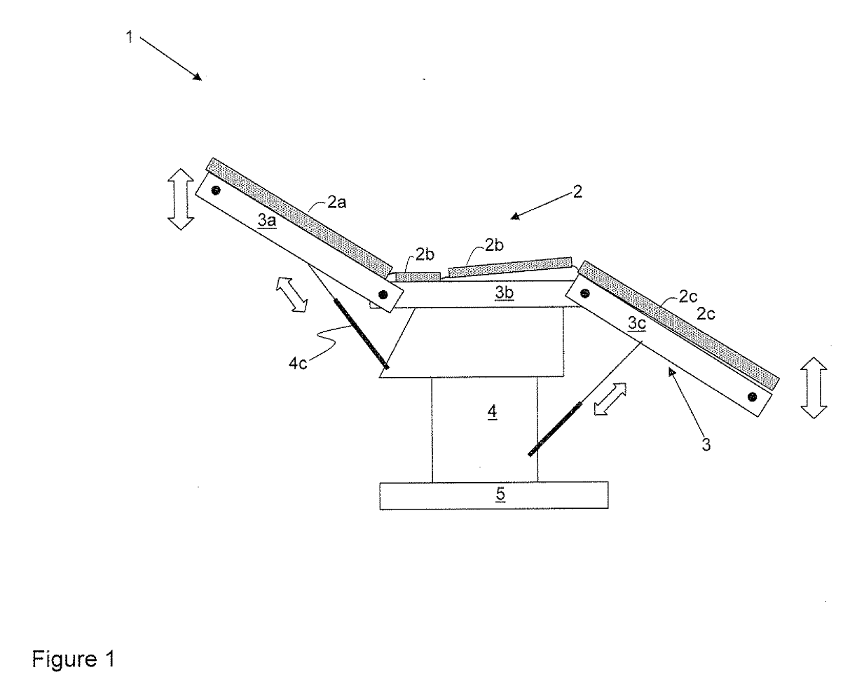

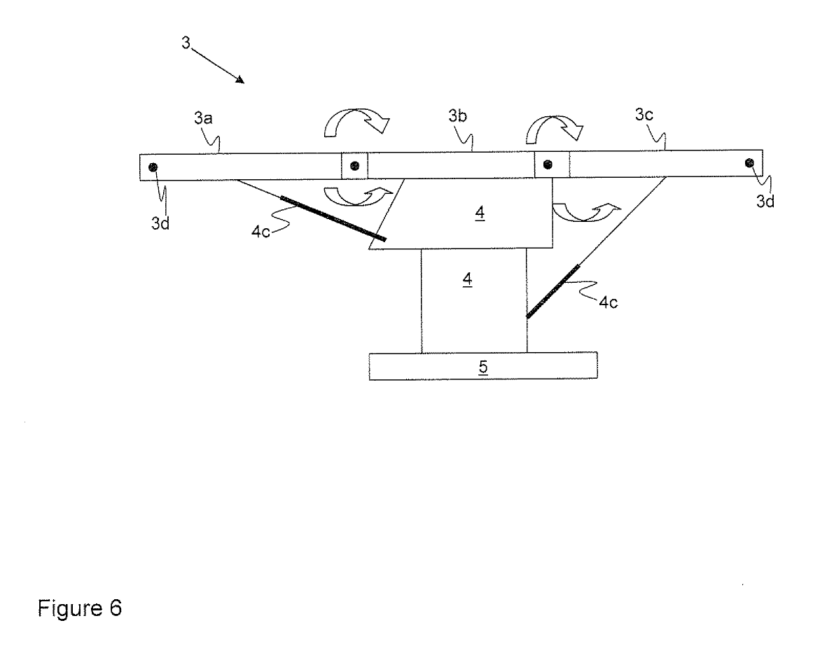

The principles and operation of the method according to the present invention may be better understood with reference to the drawings and the accompanying description. Turning now to the figures, FIG. 1 depicts a multi-functional, convertible treatment-table, generally labeled 1, that includes, a support pad 2 releasably connected to a support frame 3, a lift mechanism 4 attached to support frame 3 and a base 5, and gas springs 4c. Support pad 2, in a non-limiting, exemplary embodiment, includes a plurality of pad segments, a head-pad segment 2a, center-pad segments 2b and a leg-pad segment 2c interconnected by way of an effective hinge 2d (most clearly seen in FIG. 8) formed from the pad covering. In non-limiting, exemplary embodiments, the pad covering is constructed from imitation leather; however, it should be appreciated that cloth, plastic, and other durable and flexible materials are also suitable materials. It should be appreciated that support pads 2 having any number of segments are included within the scope of the present invention. Each pad segment is disposed at an inclination that is defined by the degree of extension of gas springs 4c, connected to a support frame segment supporting the pad segment. As shown, the opposite end of the gas spring 4c is fixed to a surface associated with the lift mechanism 4 or base 5 as is known to those skilled in the art.

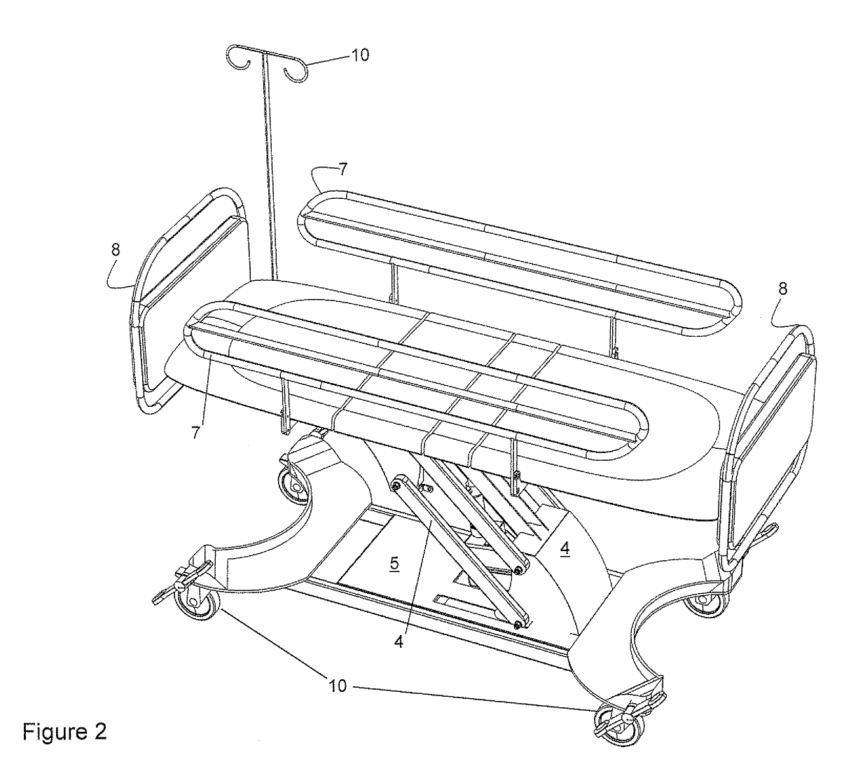

In an exemplary, non-limiting embodiment, lift mechanism 4 is powered by an electric motor 4a coupled to a pneumatic lift, a brake mechanism and support struts 4b (more clearly shown in FIG. 2) as is known to those skilled in the art.

It should be noted that the term “conversion” refers to a transformation between different types of furniture like a table, a bed, a stretcher, or a chair. The term “adaptation” refers to a modification of a particular type of furniture by changing the number, type, or orientation of the support pad or pad segments and adding needed accessories. It should be further appreciated that features depicted or explained in one configuration are applicable to all other relevant conversions and adaptations.

FIGS. 2-5 depict treatment-table 1 converted and adapted to a hospital bed having side railings 7, head and foot boards 8, transport wheels 9 and an IV stand 10. It should be noted that all types of wheels, casters, and retractable casters, are included within the scope of the present invention. As shown, all pad segments 2a-2c are disposed horizontally and the bed is held at the desired height by the lift mechanism 4

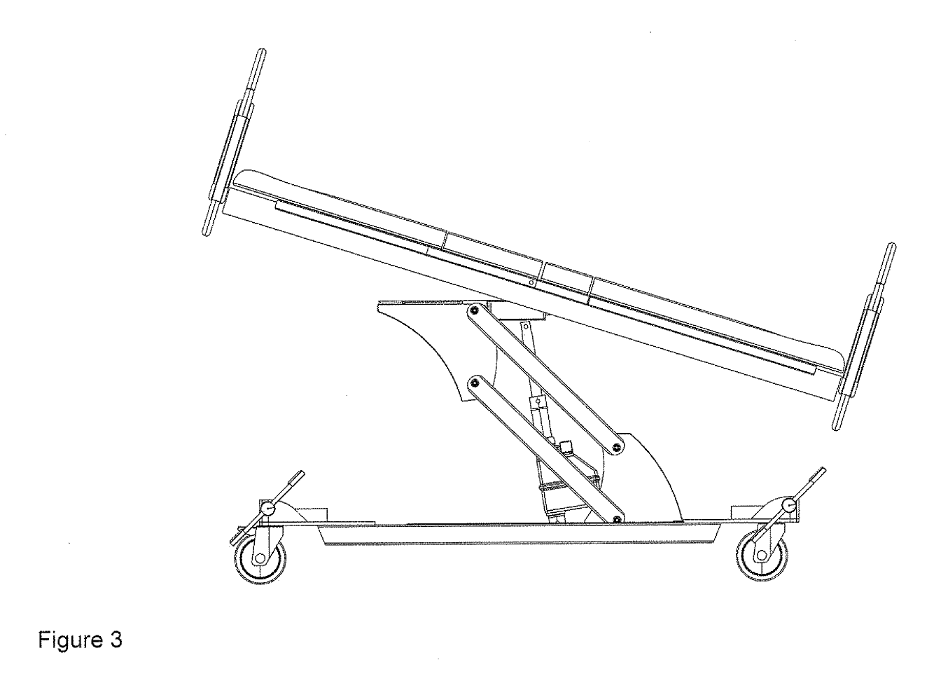

Particularly, FIGS. 2-3 depict the hospital bed tilted at various angles by lift mechanism 4 and associated support arrangement It should be noted that lift mechanism 4 is configured to hold treatment-table 1 at any height within its range of motion and at any angle of tilt relative to the horizontal within its angular range of motion as is known by those skilled in the art. FIG. 5 depicts hospital bed in a completely lowered state.

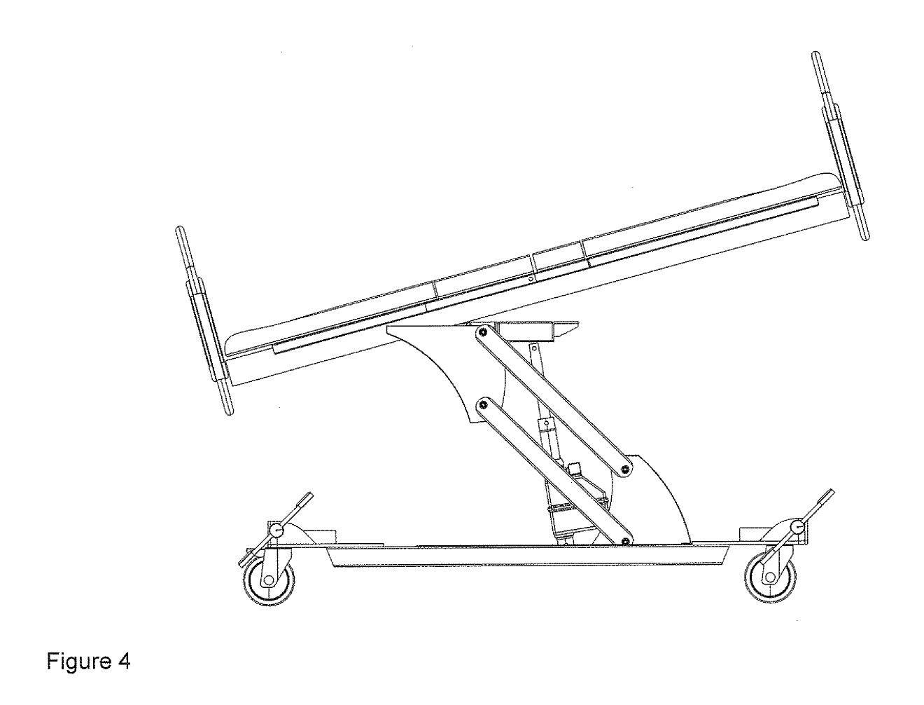

FIG. 6 depicts support frame, generally designated 3, and its three pivotally connected segments. The ability to tilt each pad segment as depicted in FIG. 1 emanates from the pivotal frame segments supporting those pad segments and are held in the desired position by by gas springs 4c as noted above. The pivotal connection between frame segments 3a and 3b and between 3b and 3c are connected by way of removable pins 3d or any other releasable, connection solution enabling frames 3a and 3e to be disconnected or reconnected to frame 3c in accordance to the particular needs of the patient.

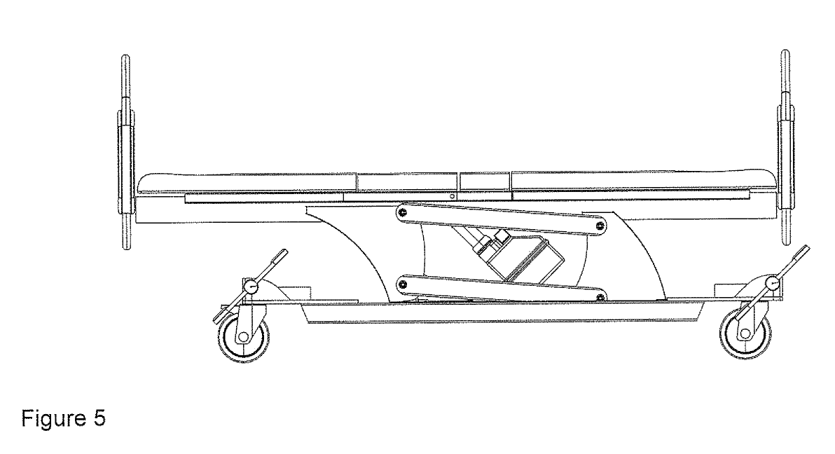

FIG. 7 depicts a bottom view of support pad 2 and its effective hinges 2d connecting adjacent pad segments 2a to 2b and 2b to 2c. Disposed on the bottom side of each of the pad segments is a releasable connector for releasably connecting pad segments 2a and 2c to the corresponding connectors disposed on top of frame segments 3a and 3c in an exemplary, non-limiting embodiment. The connectors 2e are implemented as a bolts and wing-nuts; however, it should be noted that screws, clips, clasps, or any other releasable connection configuration is included within the scope of the present invention. Furthermore, connectors 2e constructed of metallic, polymeric, or any other durable material providing the required stability is included within the scope of the present invention. In a non-limiting, exemplary embodiment, accessory support structures 4e are attached to each of frame segments 3a through 3c for holding various, medical specialty accessories as will be discussed. Accessory support structures 4e are implemented as tubes, or metallic strips or brackets, in a non-limiting exemplary embodiment.

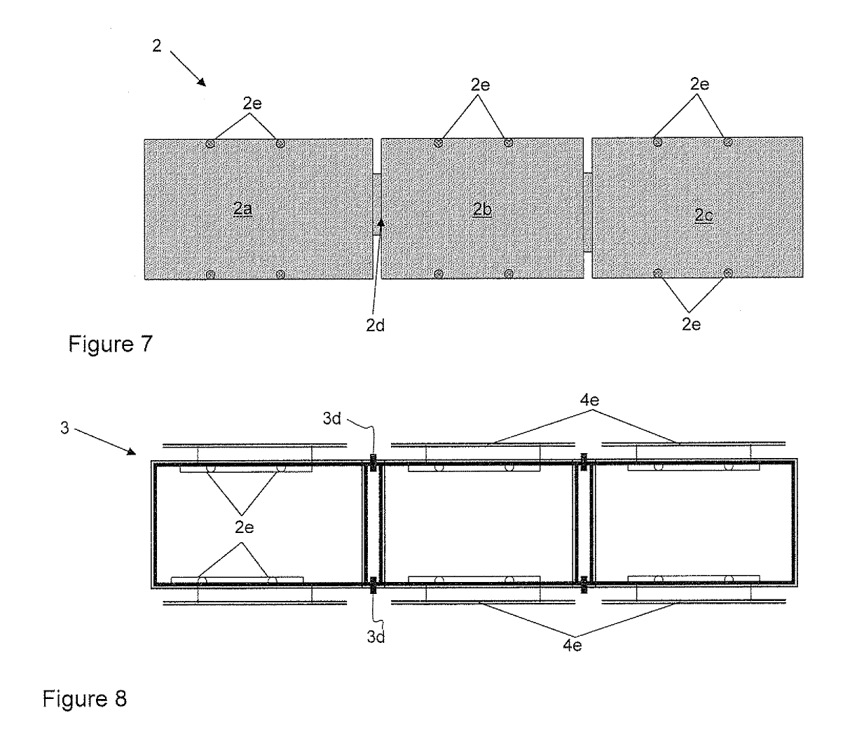

FIGS. 9-22 depict various examples of conversions and adaptations of the multi-functional, convertible treatment-table and will be referred to by the name of the particular specialty item to which it has been converted.

FIG. 9 depicts a physiotherapy table 6 having three, broad pad-segments 2a, 2b, and 2c. The broad support pad 2 facilitates especially large patients and enables a physiotherapist to work while positioned on top of support pad 2. Head pad segment 2a includes two breathing windows plugged with a plug 2f that when removed, a patient lying on pad 2 in a prone position with the face placed opposite the window is able to breath through the window.

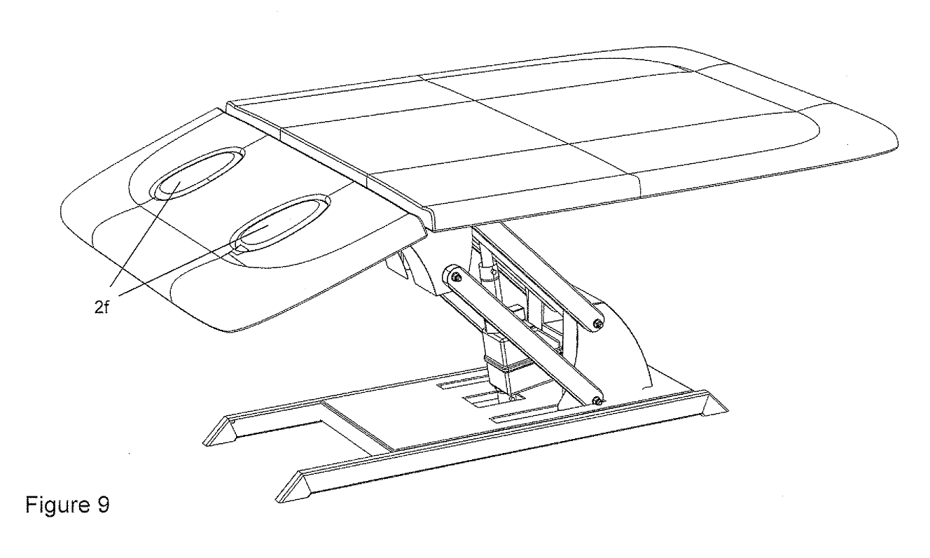

FIG. 10 depicts a two-pad, cardiovascular table in which one pad includes a recess in lateral edge so as to facilitate cable access to a patient lying on the treatment-table.

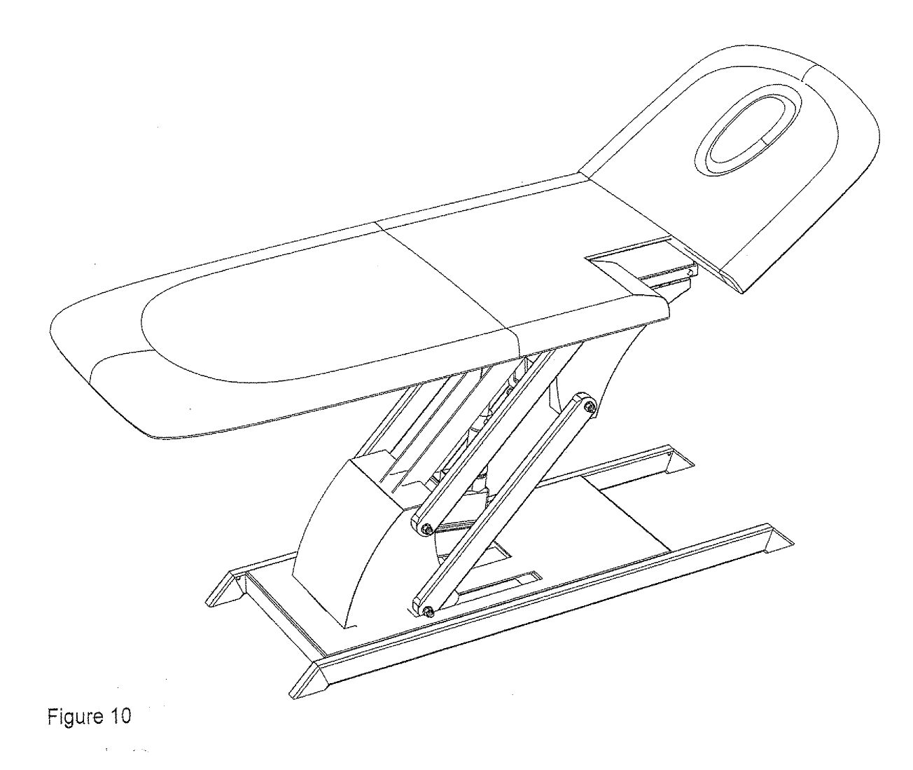

FIG. 11 depicts a stretcher equipped with handle bars 9 with wheels 10 and side railings 7. It should be noted that, in non-limiting, exemplary embodiments, the accessories are releasably connected to the accessory support element 4e shown in FIG. 8; however, it should be appreciated that accessories connected directly to the support frame 3 or to lift mechanism 4, or to base 5 are included within the scope of the present invention. Transport wheels 10 have been added to base 5 to facilitate transport over significant distances. A basket 13 is mounted on base 5 to temporarily store patient paraphernalia.

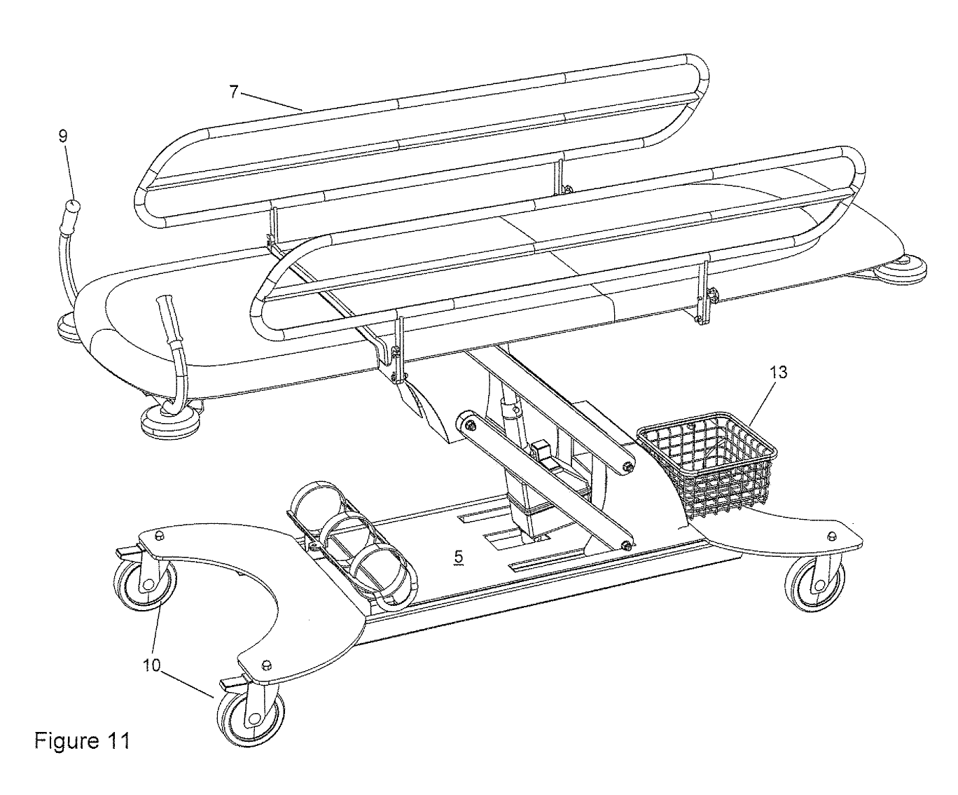

FIG. 12 depicts a proctologic table having a proctologic shelf 14 attached to a shelf-support structure 15 attached to support frame 2 in an exemplary, non-limiting embodiment. Proctologic shelf 14 is fitted with support brackets (not shown) that releasably lock into bracket slots 16 disposed in shelf-support structure 15. Bracket slots 16 are disposed at various heights in shelf-support structure 15 so as to enable a user to place proctologic shelf 14 at the desired height as shown. It should be appreciated that any connection configuration employed for releasably fastening proctologic shelf 14 to shelf-support structure 15 is included within the scope of the present invention.

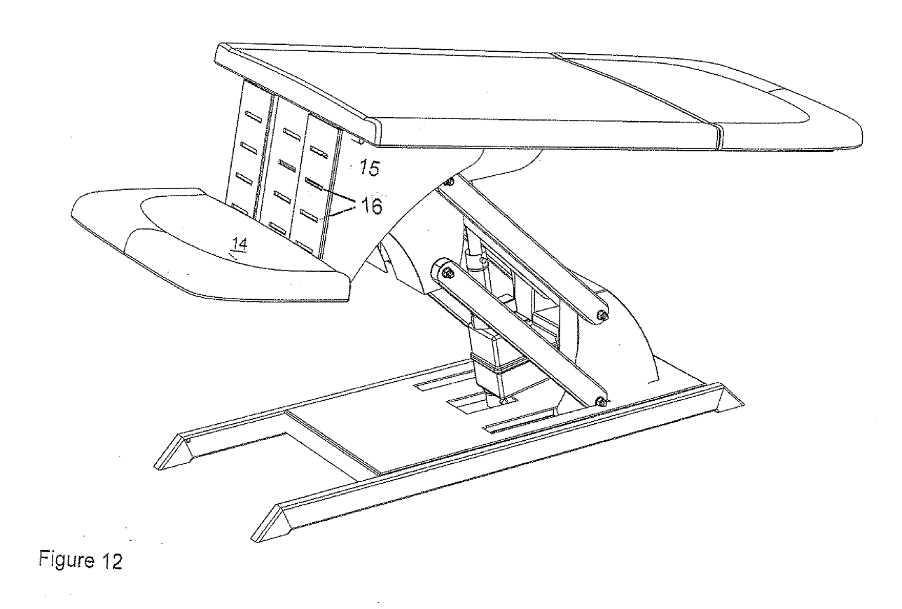

FIG. 13 depicts a combination gynecologic/urologic chair fitted with heel supports or leg rests 16 and hand grips 17 that are releasably connected to accessory support structures 4e as noted above. The gynecologic/ urologic chair are fitted with a specially adapted pad segment 2b having a recess disposed in a distal end from head pad 2a to enable bodily discharges to pass through pad 2b into a collection pan 18 disposed underneath the discharge recess. Collection pan 18 is slideably mounted in a tracks (not shown) connected to support frame 2. The collection pan 2b of the urologic chair includes a drain hole to enable liquids to feed into a drain pipe (Not shown).

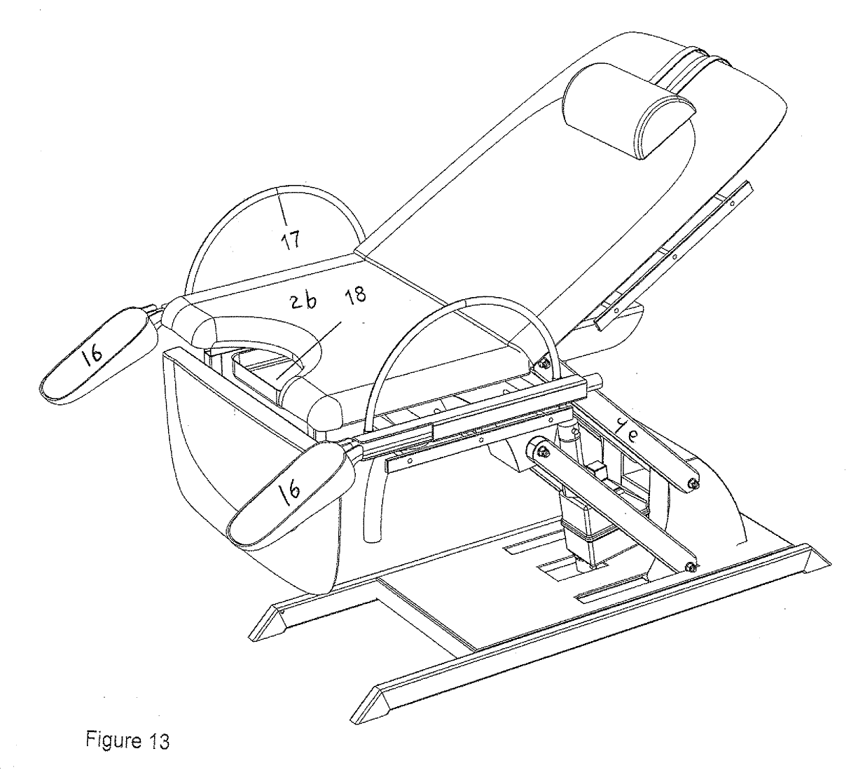

FIG. 14 depicts an otolaryngological chair configured for sitting and fitted with arm rests 19, a head rest 20 and a foot rest 21. As noted above, these accessories releasably attach to accessory support bar 4e or directly to support frame 2 as noted above.

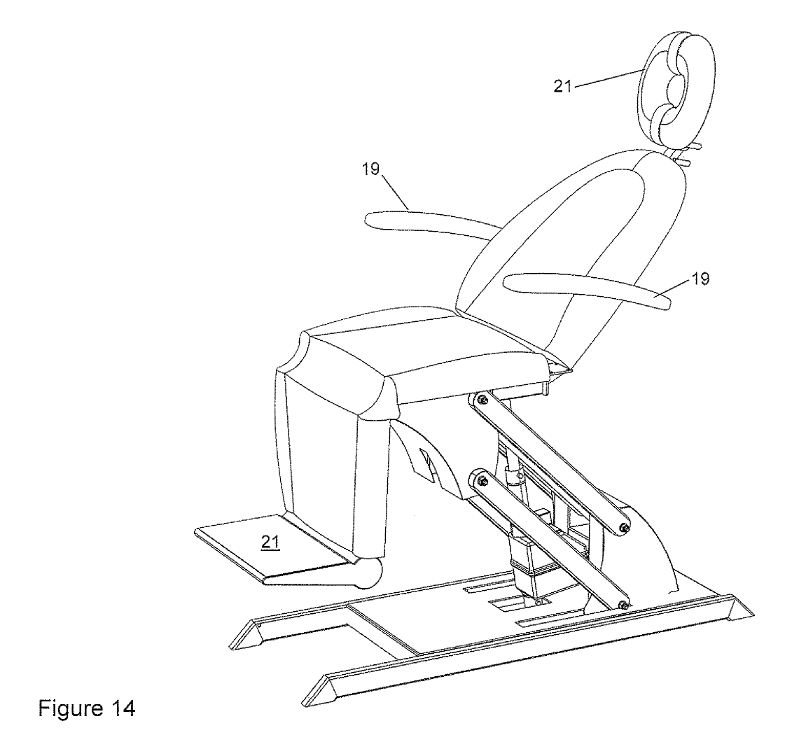

FIG. 15 depicts a casting table in which foot pad segment 2c is split into two sections to enable them to move independently. It should be noted at this point that when converting one type of furniture to another, support frame 2 must match the support pad in terms of pad segments and type. If a reduction in frame segments is required to mach the pad segments required for a particular medical application, a user removes the required frame segment by removing releasable pins 3d as shown in FIG. 8. Similarly, if an additional frame segment is required, a frame segment is connected also by way of pins 3d and if a specialized frame segment is required, it is connected to support frame 2 in the same manner in an exemplary, non-limiting embodiment. After the support frame 2 is configured to match the specialized pad segments, the appropriate support pad 2 is releasably fastened to support frame 2 by way of connectors 2e. Adaptation to the particular function is accomplished by moving each pad segment into the appropriate angle of inclination where it is held by gas springs 4c as noted above. Accessories are releasably attached to accessory support structures 4e as needed. The converted and adapted treatment-table is elevated to the appropriate height and inclination by way of the lift mechanism. In non-limiting embodiments, the actuation switch is implemented as step bar enabling the practitioner to change the height of the furniture while his hands are occupied as is known in the art. If transport wheels or caster wheels are required, they are added to base 5. It should be noted that the order of these events is immaterial with the exception of adapting support frame segments to support pads in which the frame configuration must precede their connection to the pad segments.

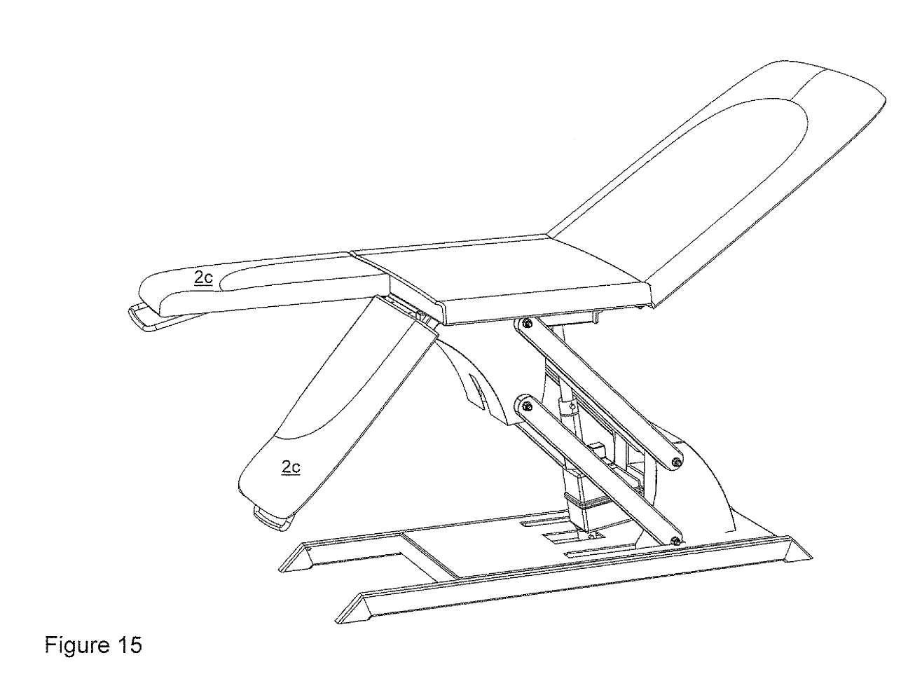

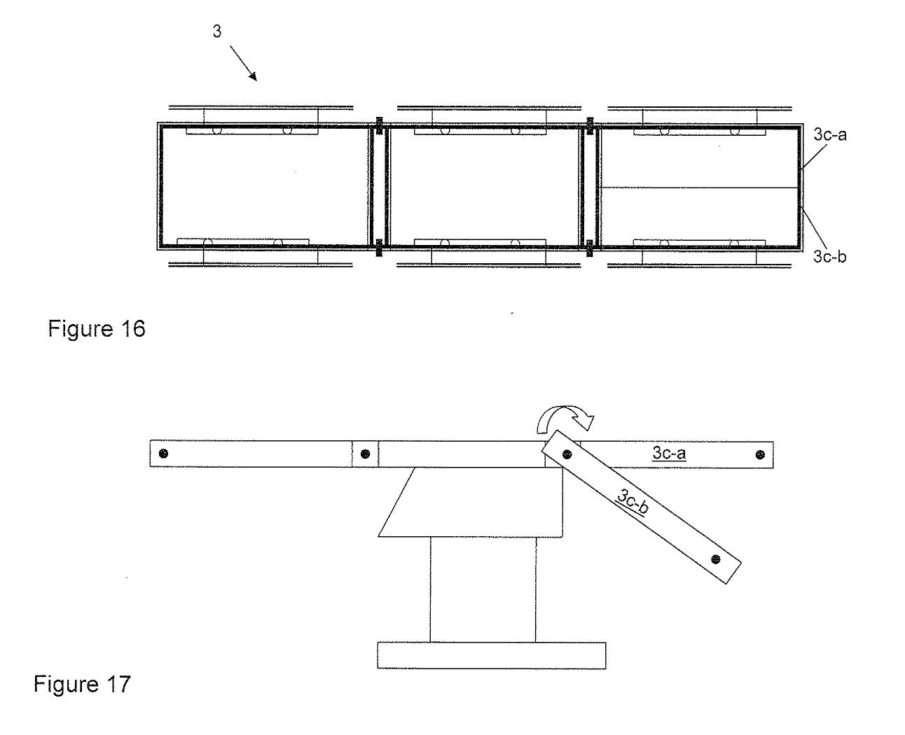

FIG. 16 depicts support frame 3 with an adapted support frame segment including two independently pivotal sections 3c-a and 3c-b onto which a correspondingly split pad is releasably attached to provide the functionality depicted in FIG. 15. FIG. 17 is a side view of the above-described frame segment configuration.

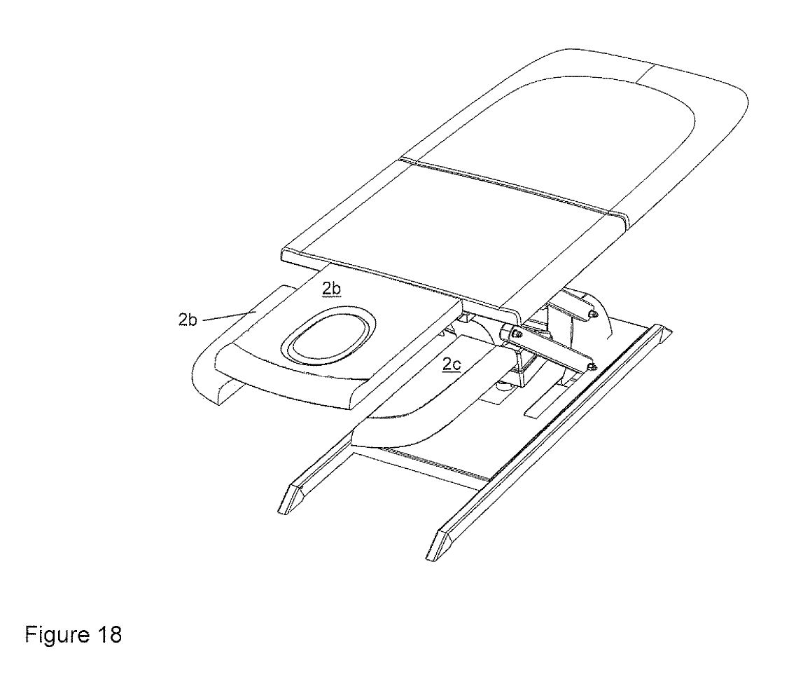

FIG. 18 depicts a chiropractic table also having a specialized head pad segment 2a including three separate sections enabling either independent or concurrent movement of the two outer sections 2a-a and 2a-c or of all three sections 2a-a, 2a-b, 2a-c.

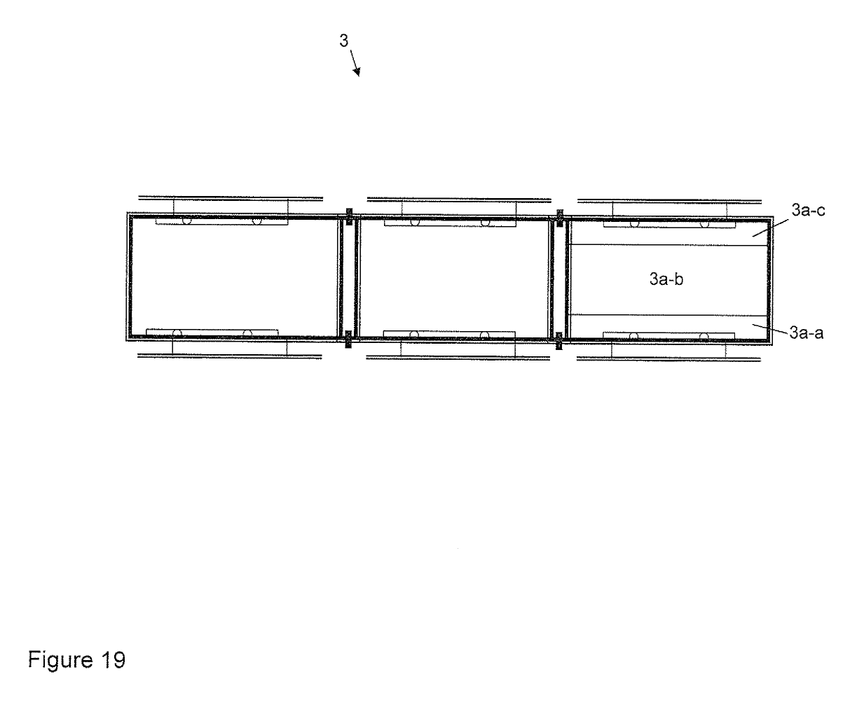

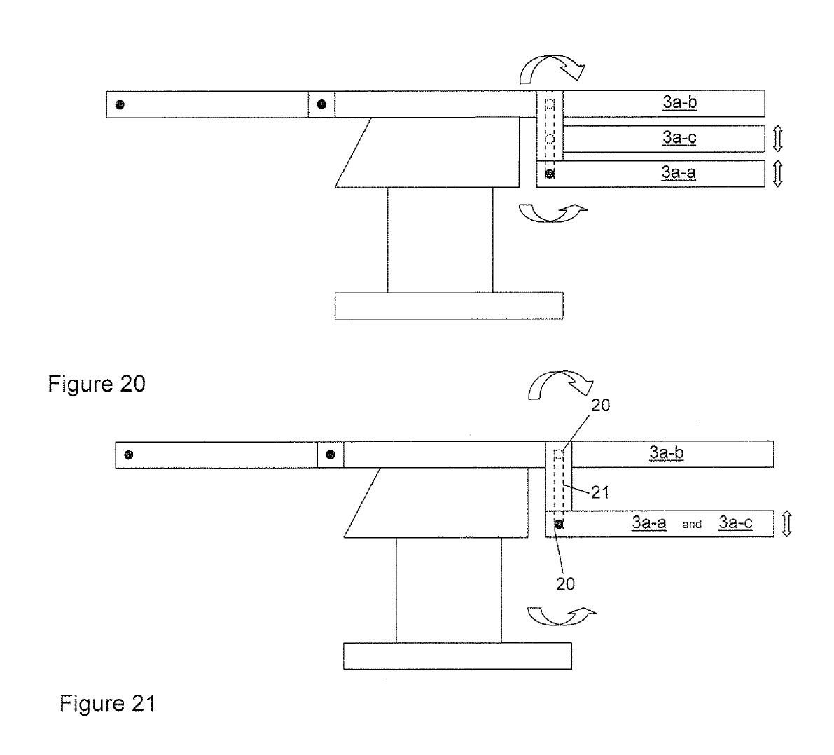

FIGS. 19-21 depict top and side views of the modified support frame 3 providing such functionality. Specifically, frame segment 3a is divided into three independently pivotal sections 3a-a, 3a-b, 3a-c, each pivoting around its; own independent axle 20 disposed in a vertical track 21. This configuration advantageously enables, in a non-limiting exemplifying embodiment, each of the three sections 3a-a, 3a-b, 3a-c to move linearly in substantially vertical track 21 and to rotate around its own axle 20 at any height within track 21. FIG. 20 depicts outer sections 3a-a and 3a-c moving independently and FIG. 21 depicts those same sections moving concurrently.

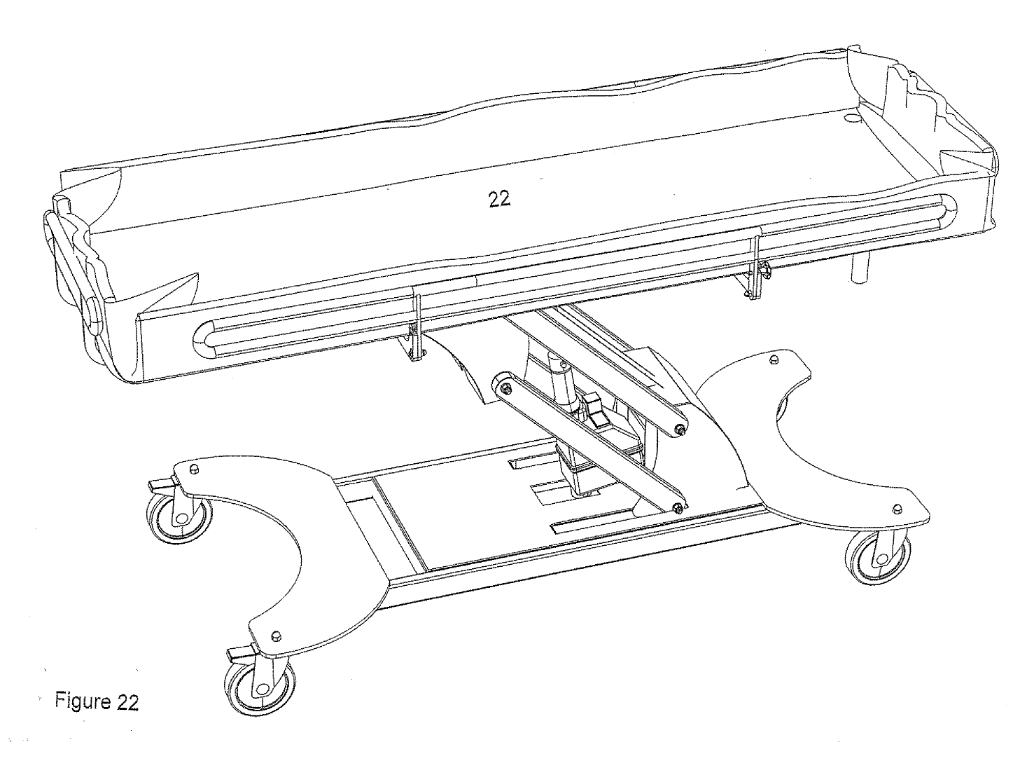

FIG. 22 depicts a washing bed support pad 2 having a hydrophobic sheet 22 to enable washing a patient in the bed. A drain hole (not shown) is provided to remove the water.

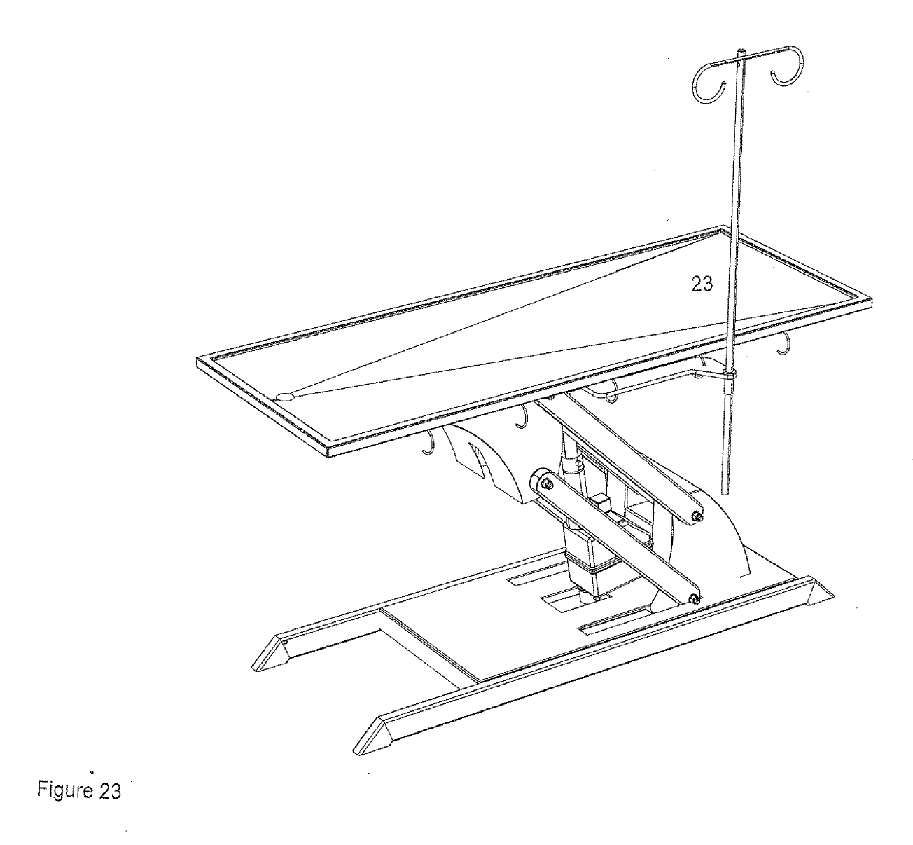

FIG. 23 depicts a veterinarian table in which metallic platfoirn 23 is fixed to support frame (not shown). An instrument tray 24 is fixed to the platform 23.

Additional, non-limiting examples of medical furniture to which the multi-functional, treatment-table can be converted include a cosmetician's chair and an operating table.

It will be appreciated that the above descriptions are intended only to serve as examples, and that many other embodiments are possible within the scope of the present invention as defined in the appended claims.

What is claimed is:

1. A multi-functional, convertible treatment-table comprising:
(a) a support frame having at least two, pivotally connected frame segments enabling at least one of said segments to form an angle of inclination relative to a horizontal plane; said frame segments having a plurality of connection configurations for releasably connecting interchangeable furnishings to any one of said frame segments;
(b) a lift mechanism configured to vary the height of said support frame; and
(c) an interchangeable furnishing releasably connected to at least one of said frame segments, thereby enabling the table to be converted to specialized piece of equipment in accordance with patient needs.

2. The multi-functional, convertible treatment-table of claim 1, wherein said lift mechanism is further configured to change an angle of inclination of at least one support frame segment.

3. The multi-functional, convertible treatment-table of claim 1, wherein said interchangeable furnishing includes a support pad.

4. The multi-functional, convertible treatment-table of claim 3, wherein said support pad includes a plurality of pad segments.

5. The multi-functional, convertible treatment-table of claim 4, wherein said support pad segment includes a plurality of separate, pad sections enabling independent motion of at least one of said pad sections.

6. The multi-functional, convertible treatment-table of claim 3, wherein said support pad includes a recess in lateral edge so as to facilitate cable access to a patient lying on the treatment-table.

7. The multi-functional, convertible treatment-table of claim 3, wherein said support pad includes a discharge recess in a distal edge so as to enable bodily discharges from a patient on the treatment-table to pass through said support pad.

8. The multi-functional, convertible treatment-table of claim 7, further comprising a collection pan for receiving the bodily discharges, said collection pan being disposed directly underneath the discharge recess.

9. The multi-functional, convertible treatment-table of claim I, further comprising at least one accessory associated with the treatment-table.

10. The multi-functional, convertible treatment-table of claim 9, wherein said accessory includes a proctologic shelf.

11. The multi-functional, convertible treatment-table of claim 9, wherein said accessory includes a metallic platform.

12. A method for converting a multi-functional, convertible treatment-table comprising:
(a) providing:
i. a support frame having at least two, pivotally connected frame segments enabling at least one of said segments to form an angle of inclination relative to a horizontal plane; said frame segments having a plurality of connection configurations for releasably connecting interchangeable furnishings to said frame segments,
ii. a lift mechanism configured to vary the height of said support frame,
iii. a first interchangeable furnishing releasably connected to at least one of said frame segments;
(b) releasing said first interchangeable furnishing from said frame segment; and
(c) releasably connecting a second, interchangeable furnishing to said frame so as to adapt the treatment-table according to patient needs.

13. The method of claim 12, further comprising a step of replacing one of said frame segments with a frame segment having a plurality of pivotal sections.

14. The method of claim 13, wherein said second interchangeable furnishing includes a support pad segment having a plurality of separate, pad sections enabling independent motion of at least one of said pad sections.

15. The method of claim 12, further comprising a step of adding an accessory associated with the treatment-table.

14. The method of claim 12, wherein said accessory includes a wheel set so as to facilitate transport of the treatment-table.

16. The method of claim 15, wherein said accessory includes a proctologic shelf.

17. The method of claim 15, wherein said accessory includes gynecologic leg rests.

18. The method of claim 17, further comprising adding a collection pan for receiving bodily discharges from a patient on the treatment-table.

19. The method of claim 12, wherein said second interchangeable furnishing includes a metallic platform.
